(19) United States
(12) Patent Application Publication
(10) Pub. No.: US 2017/0144646 A1
(43) Pub. Date: May 25, 2017

(54) WHEEL FOR PREVENTING JACKKNIFING AND UNEVEN TIRE WEAR IN VEHICLES

(71) Applicant: Edward Earl Bonds, Ohatchee, AL (US)

(72) Inventor: Edward Earl Bonds, Ohatchee, AL (US)

(21) Appl. No.: 15/272,198

(22) Filed: Sep. 21, 2016

Related U.S. Application Data
(60) Provisional application No. 62/221,163, filed on Sep. 21, 2015.

(51) Int. Cl. B60W 20/10; B60K 6/52; B60K 7/00; H02K 1/12; H02K 7/08; H02K 11/20; H02K 11/30; B62D 53/06; H02K 1/27

(52) U.S. Cl. CPC B60W 20/10; B62D 53/06; B60K 6/52; B60K 7/0007; H02K 1/2786; H02K 7/086; H02K 11/20; H02K 11/30; H02K 1/12; Y10S 903/93; Y10S 903/916; B60Y 2200/92; B60Y 2200/148; B60Y 2300/188; B60Y 2300/24; B60Y 2300/60; B60B 27/0015

(57) ABSTRACT

Disclosed is a vehicle including a plurality of wheels mounted on at least one axle. Additionally, the vehicle includes a plurality of electric motors corresponding to the plurality of wheels. Further, each electric motor of the plurality of electric motors is operationally coupled to the at least one axle corresponding to a respective wheel of the plurality of wheels. Moreover, the vehicle includes at least one sensor configured to sense a state of at least one part of the vehicle. Further, the vehicle includes a controller configured to control operation of each of the plurality of electric motors based on the state of at least one part of the vehicle. Additionally, the controller is further configured to control operation of at least one electric motor independent of controlling operation of at least one other electric motor of the plurality of electric motors.

### CROSS-REFERENCE TO RELATED APPLICATIONS

This application claims priority from a provisional patent application No. 62/180,979, filed on Sep. 21, 2015, titled “In-Wheel Motor for Vehicles” which is incorporated herein by reference in its entirety.

### FIELD OF THE DISCLOSURE

Generally, the disclosure relates to an in-wheel motor that provides propulsion capabilities to each wheel mounted on an axle of a vehicle in accordance with an external electrical input or a sensor-driven signal. More specifically, the disclosure relates to a vehicle and/or wheels propelling the vehicle configured to prevent one or more of jackknifing and uneven tire wear on the wheels of the vehicle.

### BACKGROUND

Traditional tractor trailers or semi-trailer trucks or 18 wheelers are commonly used to transport freight or cargo from one location to another. These tractor trailers cover large distances in a single journey, driving along uneven roads, dangerous curves, and slender roadways. To ensure the safety of a driver and a vehicle while executing such heavy and risky assignments, the tractor trailers are outfitted with a wider wheel base having dual-wheel combinations, an air pressure braking technology, and various vehicle transmission modes. But, a large number of truck trailer accidents are recorded which had happened only because of jackknifing and rolling over.

The term jackknifing refers to a scenario in which the tractor trailer towing a trailer unit skids and then subsequently the trailer unit pushes the tractor unit from behind until the tractor unit spins around and faces rearwards. Furthermore, the tractor trailers also fall victim to rollover accidents when the tractor trailer makes turn at an angle of 90 degrees or more about any lateral axis.

The trailer may jackknife while traveling over hazardous road conditions, or if the driver takes a turn too aggressively. Because the trailer unit in a tractor trailer is generally an unpowered system, the drivers have minimal control over how the trailer responds to environmental changes. Further, factors such as speed, gravity, friction, suspension, center of gravity, and centrifugal force play a role in triggering jackknifing of the trailer.

Another problem observed in vehicles is the uneven wearing of tires on the different wheels. For example, when a vehicle travels in a curved trajectory (e.g. a right turn), the wheels on one side of the vehicle (e.g. left side) may have to cover a larger distance within a time compared to the wheels on the opposite side of the vehicle (e.g. right side). Since the wheels are connected to a common axle, the speeds of rotation of the wheels on both sides of the vehicle are the same. Therefore, the wheels on the side of the vehicle which needs to cover the larger distance experience a dragging against the road.

This dragging causes the wheels to wear out more compared to the wheels that do not experience dragging.

Therefore, there is a need for methods, systems, and apparatuses for solving one or more of the above mentioned problems.

### SUMMARY

Disclosed is a vehicle including a plurality of wheels mounted on at least one axle. Additionally, the vehicle includes a plurality of electric motors corresponding to the plurality of wheels. Further, each electric motor of the plurality of electric motors is operationally coupled to the at least one axle corresponding to a respective wheel of the plurality of wheels. Furthermore, an electric motor operationally coupled to an axle is configured to rotationally drive the axle based on electrical power supplied to the electric motor. Moreover, the vehicle includes at least one sensor configured to sense a state of at least one part of the vehicle. Further, the vehicle includes a controller configured to control operation of each of the plurality of electric motors based on the state of at least one part of the vehicle. Additionally, the controller is further configured to control operation of at least one electric motor independent of controlling operation of at least one other electric motor of the plurality of electric motors.

Further disclosed is a wheel configured to propel a vehicle. The wheel may include a vehicle attachment mechanism configured to attach the wheel to an axle of the vehicle. Additionally, the wheel may include an electrical power unit comprising an electrical interconnect and a stationary winding assembly. The stationary winding assembly may be configured to generate an electromagnetic field. Further, the electrical interconnect may be configured to receive at least one of electrical power to energize the stationary winding assembly and a control signal to control electrical power delivered to the stationary winding assembly. Furthermore, the wheel may include a stator configured to be mounted onto the axle. Additionally, the stator may include a bearing mount and a power unit mount. The bearing mount may be configured to function as a connection point for the wheel bearing whereas the power unit mount may be configured to function as a connection point for the electronic power unit to be mechanically fastened to the stator. Further, the wheel may include a wheel rim rotor comprising an annular array of magnets configured to interact with the electromagnetic field generated by the stationary winding assembly to generate a repulsive force which impels the wheel rim rotor to rotate about a longitudinal axis of the axle. Furthermore, the wheel may include a wheel bearing configured to form a connection point between the wheel rim rotor and the axle. Additionally, the wheel bearing may be configured to enable the wheel rim rotor to rotate about the longitudinal axis of the axle. Further, the wheel may include at least one sensor configured to sense at least one of an environmental condition of the vehicle and a state of the wheel. Furthermore, the wheel may include a controller configured to control electric power delivered to the stationary winding assembly based on at least one of the environmental condition and the state of the wheel. Moreover, the controller may be configured to at least partially prevent jackknifing of the vehicle.

### BRIEF DESCRIPTION OF DRAWINGS

FIG. 1 illustrates a block diagram of a vehicle configured to prevent one or more of jackknifing and uneven tire wear on wheels, in accordance with an embodiment.

FIG. 2 illustrates a schematic diagram showing a wheel of the vehicle, in accordance with an embodiment.

FIG. 3 illustrates the schematic diagram of an axle of the vehicle, in accordance with an embodiment.

FIG. 4 illustrates a schematic diagram of the vehicle comprising a tractor and one or more trailers, in accordance with an embodiment.

FIG. 5 illustrates a schematic diagram showing a hitch of the vehicle, in accordance with an embodiment.

FIG. 6 illustrates a schematic diagram showing a converter dolly of the vehicle configured to interconnect two segments of the vehicle, such as for example, the tractor and the trailer, in accordance with an embodiment.

FIG. 7A illustrates a schematic diagram showing a side-view of the vehicle, such as for example, an eighteen wheeler, in accordance with an embodiment.

FIG. 7B illustrates a schematic diagram showing a bottom-view of the vehicle, such as for example, the eighteen wheeler, in accordance with an embodiment.

FIG. 8A-8B illustrates a front view and a back view of a wheel configured to prevent one or more of jackknifing and uneven tire wear on wheels of the vehicle, in accordance with an embodiment.

FIG. 9 illustrates a perspective view of the wheel with an attached tire, in accordance with an embodiment.

FIG. 10 illustrates an isometric perspective view of the wheel, in accordance with an embodiment.

FIG. 11A illustrates an exploded perspective view of the wheel, in accordance with an embodiment.

FIG. 11B illustrates another exploded perspective view of the wheel, in accordance with an embodiment.

FIG. 12 illustrates a flowchart depicting operations of a controller, in accordance with an embodiment.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary.

### Overview:

According to some embodiments, a wheel configured to propel a vehicle is disclosed such that one or more of jackknifing and tire wear may be prevented. Accordingly, the wheel may include a vehicle attachment mechanism configured to attach the wheel to an axle of the vehicle. Additionally, the wheel may include an electrical power unit comprising an electrical interconnect and a stationary winding assembly. The stationary winding assembly may be configured to generate an electromagnetic field. Further, the electrical interconnect may be configured to receive at least one of electrical power to energize the stationary winding assembly and a control signal to control electrical power delivered to the stationary winding assembly. Furthermore, the wheel may include a stator configured to be mounted onto the axle. Additionally, the stator may include a bearing mount and a power unit mount. The bearing mount may be configured to function as a connection point for the wheel bearing whereas the power unit mount may be configured to function as a connection point for the electronic power unit to be mechanically fastened to the stator. Further, the wheel may include a wheel rim rotor comprising an annular array of magnets configured to interact with the electromagnetic field generated by the stationary winding assembly to generate a repulsive force which impels the wheel rim rotor to rotate about a longitudinal axis of the axle. Furthermore, the wheel may include a wheel bearing configured to form a connection point between the wheel rim rotor and the axle. Additionally, the wheel bearing may be configured to enable the wheel rim rotor to rotate about the longitudinal axis of the axle. Further, the wheel may include at least one sensor configured to sense at least one of an environmental condition of the vehicle and a state of the wheel. Furthermore, the wheel may include a controller configured to control electric power delivered to the stationary winding assembly based on at least one of the environmental condition and the state of the wheel. Moreover, the controller may be configured to at least partially prevent jackknifing of the vehicle.

Additionally, in some embodiments, the wheel may further include a tire mount attached to an exterior surface of the wheel rim rotor. Further, the tire mount may be configured to mount a tire onto the wheel.

Additionally, in some embodiments, the vehicle attachment mechanism may include a mechanical fastening assembly configured to connect the wheel to a suspension system of the vehicle. Further, in some embodiments, the vehicle attachment mechanism may be configured to form a detachable connection between the wheel and the vehicle.

Accordingly, in some embodiments, the vehicle attachment mechanism may include a plurality of mechanical fasteners configured to fixedly connect the stator to the vehicle. Further, in some embodiments, the vehicle attachment mechanism may include a clamping device configured to securely fasten the wheel to the suspension system.

Additionally, in some embodiments, the wheel may include a stator mount configured to serves as a connection point to maintain the stator in a desired position and orientation relative to the axle of the vehicle. Further, the wheel may include a plurality of hub fasteners configured to connect the stator to the stator mount.

In some embodiments, the controller may be further configured to control electrical power delivered to the stationary winding assembly in order to optimize power transfer for propulsion while minimizing power dissipated through friction. As a result, wearing of tires may be at least partially minimized Additionally, uneven wearing of tires of the vehicle may also be at least partially reduced.

Further, disclosed is a vehicle configured to prevent one or more of jackknifing and minimizing tire wear. The vehicle includes a plurality of wheels mounted on at least one axle. Additionally, the vehicle includes a plurality of electric motors corresponding to the plurality of wheels. Further, each electric motor of the plurality of electric motors is operationally coupled to the at least one axle corresponding to a respective wheel of the plurality of wheels. Furthermore, an electric motor operationally coupled to an axle is configured to rotationally drive the axle based on electrical power supplied to the electric motor. Moreover, the vehicle includes at least one sensor configured to sense a state of at least one part of the vehicle. Further, the vehicle includes a controller configured to control operation of each of the plurality of electric motors based on the state of at least one part of the vehicle. Additionally, the controller is further configured to control operation of at least one electric motor independent of controlling operation of at least one other electric motor of the plurality of electric motors.

In some embodiments, the vehicle may include a plurality of segments. Further, at least two adjacent segments are interconnected through a hitch. In some embodiments, the plurality of segments may include a tractor and a trailer. Accordingly, the tractor may include an engine configured to propel the tractor. As a result, the trailer is towed by the tractor.

Additionally, in some embodiments, the plurality of segments may include a tractor and a plurality of trailers. Accordingly, the tractor may include an engine configured to propel the tractor, while the plurality of trailers is towed by the tractor.

Furthermore, in some embodiments, the at least two adjacent trailers of the plurality of trailers are interconnected through a converter dolly. Further, the converter dolly includes at least one dolly wheel mounted on at least one dolly axle. Furthermore, each dolly wheel includes an electric motor operationally coupled to the at least one dolly axle. Additionally, the controller is further configured to control operation of the electric motor comprised in each dolly wheel based on the state of at least one part of the vehicle.

Further, in some embodiments, each wheel of the plurality of wheels includes a respective electric motor of the plurality of electric motors. Furthermore, the respective electric motor is integrated in a hub of each wheel.

Additionally, in some embodiments, each wheel includes a stator configured to be mounted onto the at least one axle corresponding to respective wheel. Further, the stator comprises a stationary winding assembly configured to generate an electromagnetic field. Further, each wheel includes a rotor configured to be mounted on the at least one axle corresponding to respective wheel via a wheel bearing. Further, the rotor includes an annular array of magnets. Accordingly, the electromagnetic field generated by the stator impels the rotor to rotate about a longitudinal axis of the at least one axle corresponding to respective wheel.

In some embodiments, each wheel may further include a tire mount configured to mount a tire onto a respective wheel.

In some embodiments, the controlling operation of each electric motor includes controlling one or more of a magnitude, a frequency and a polarity of the electromagnetic field generated by the stationary winding assembly of respective electric motor.

In some embodiments, the state of the at least one part of the vehicle includes at least one of a direction of motion, a speed, an acceleration and a deceleration of the at least one part.

In some embodiments, the vehicle includes each of a tractor and a trailer. Accordingly, the tractor includes an engine configured to propel the tractor. Further, the trailer is towed by the tractor. Additionally, the trailer is mounted onto the at least one axle. Further, the at least one part of the vehicle includes the tractor.

In some embodiments, the at least one sensor is further configured to sense an environmental condition corresponding to the vehicle. Accordingly, the controller is further configured to control operation of each electric motor based further on the environmental condition.

In some embodiments, the controller includes a wireless transmitter capable of wirelessly transmitting control commands to each of the plurality of electric motors.

In some embodiments, the state of the tractor is indicative of a possible occurrence of jackknifing. Accordingly, controlling operation of each electric motor includes generating a braking action at respective wheel.

In some embodiments, the at least one wheel corresponding to the at least one electric motor and at least one other wheel corresponding to the at least one other electric motor are each mounted on a common axle.

In some embodiments, the state of the at least one part of the vehicle includes a curved trajectory of the vehicle. Accordingly, the controller is configured to operate the at least one electric motor at a first speed and the at least one other electric motor at a second speed based on the curved trajectory.

Further, in some embodiments, the controller is configured to operate each of the at least one electric motor and the at least one other electric motor to optimize power transfer for propulsion while minimizing power dissipated through friction.

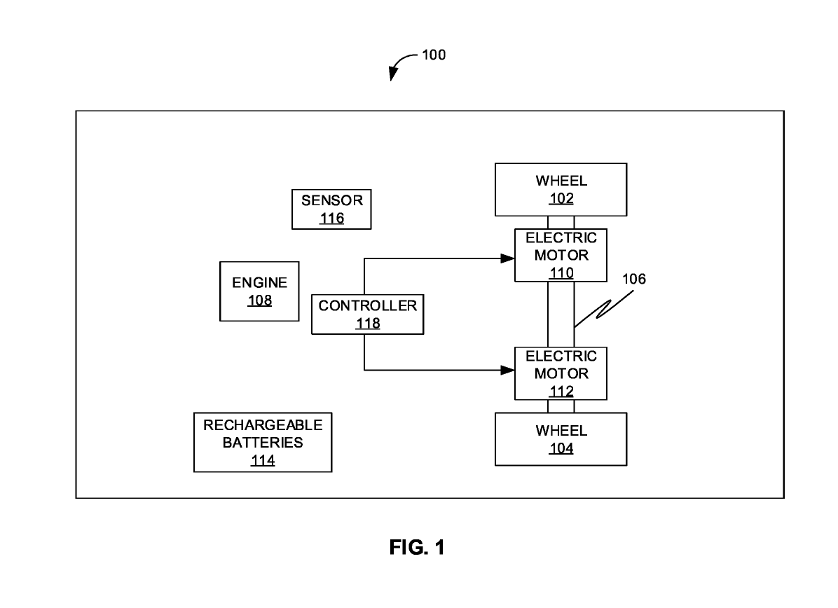

FIG. 1 illustrates a block diagram of a vehicle 100 configured to prevent one or more of jackknifing and uneven wear on tires of the wheels of the vehicle 100 in accordance with some embodiments. The vehicle 100 may include a plurality of wheels, such as for example, wheels 102-104. Further, in some embodiments, the vehicle may be a self-driven road vehicle having an assembly of the plurality of wheels 102-104. In another embodiment, the vehicle 100 may be configured with different wheel configurations such as, but not limited to, two wheels, three wheels, four wheels, six wheels, ten wheels, or eighteen wheels. Further, in one embodiment, the vehicle 100 may be designed to carry one or more passengers. Accordingly, some non-limiting examples of the vehicle 100 may include a bike, a scooter, a bus, a van, a jeep, and a car. In another embodiment, the vehicle 100 may be specifically configured to function as a freight carrier, and may be such as for example, a truck, a tractor, a lorry, a truck-trailer combination, and an eighteen wheeler. Further, in accordance with a purpose of the vehicle 100, the vehicle 100 may be configured to perform a heavy duty or a light duty operation.

The vehicle 100, mentioned in accordance with the present disclosure, may be propelled by an engine 108. The engine 108 of the vehicle 100 may be configured to perform the conversion of an energy from one form into a mechanical energy. For instance, the engine 108 may be an internal combustion engine. Accordingly, heat energy may be generated from combustion of a fuel in a controlled fuel chamber. The mechanical energy associated with vehicle 100 may be the propulsion force exerted onto the vehicle 100 to move the vehicle 100 from one point to another point. The fuel burned in the vehicle 100 may be in the form of one or more of a liquid, a gas and a solid. Alternatively, in some embodiments, the engine 108 may be configured to convert electrical energy into mechanical energy. For instance, the engine 108 may be an electric motor powered by rechargeable batteries situated in the vehicle 100. Furthermore, in some embodiments, the engine 108 may be hybrid configured to generate mechanical energy using varied categories of energy sources such as, but not limited to, gasoline, diesel, clean natural gas (CNG), liquefied petroleum gas (LPG), and electric current.

Further, the engine 108 of the vehicle 100 may produce a torque that may be different in accordance with various parameters such as, but not limited to, a size of the vehicle 100 and a payload to be carried.

Referring again to FIG. 1, in an embodiment, the plurality of wheels 102-104 of the vehicle 100 may be disposed at opposite ends of an axle 106. The axle 106 of the vehicle 100 may be a cylindrical-shaped rod or shaft which is configured to transmit a torque to the plurality of wheels 102-104. In addition, the axle 106 may also maintain the alignment of the plurality of wheels 102-104. The torque may be generated, for example, by movement of a piston of the engine 108, which is then converted into a rotatory motion by a crankshaft. The rotatory motion may be imparted to the axle 106 and hence the plurality of wheels 102-104.

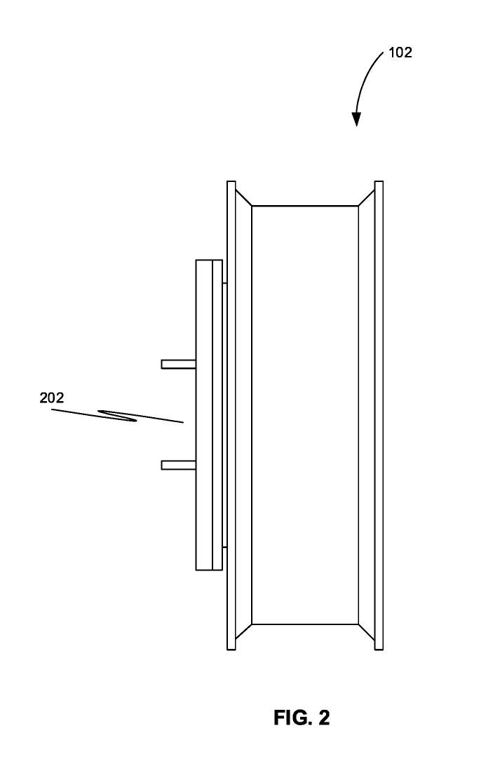

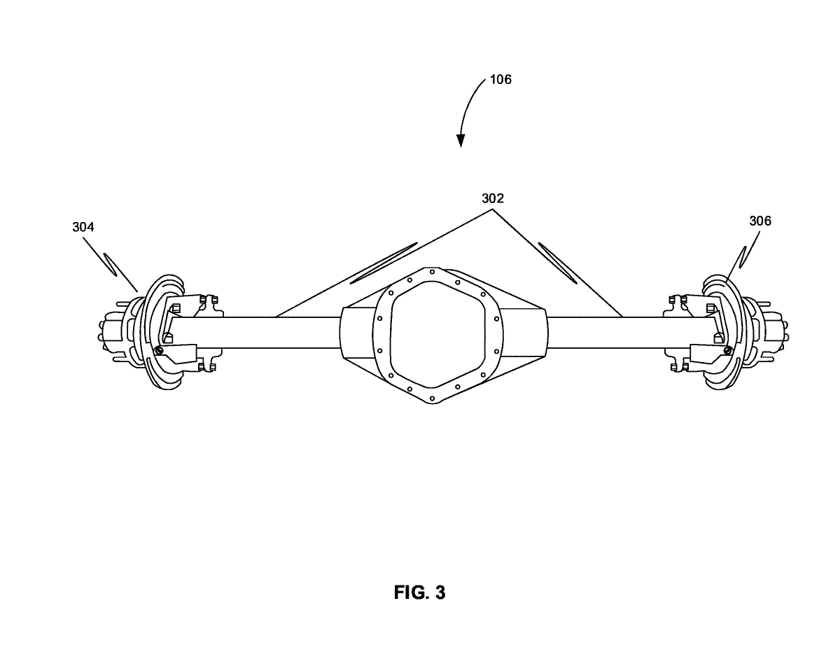

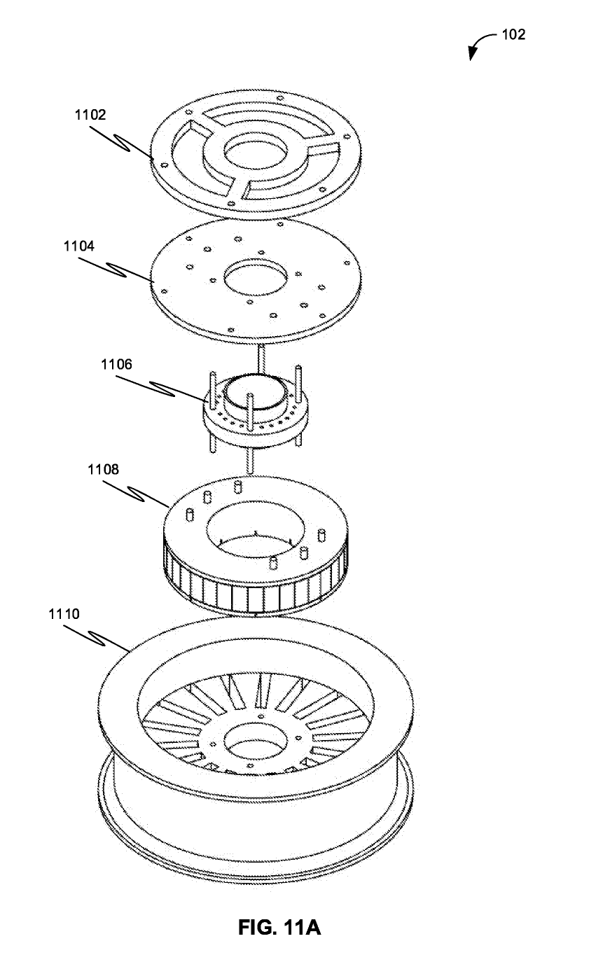

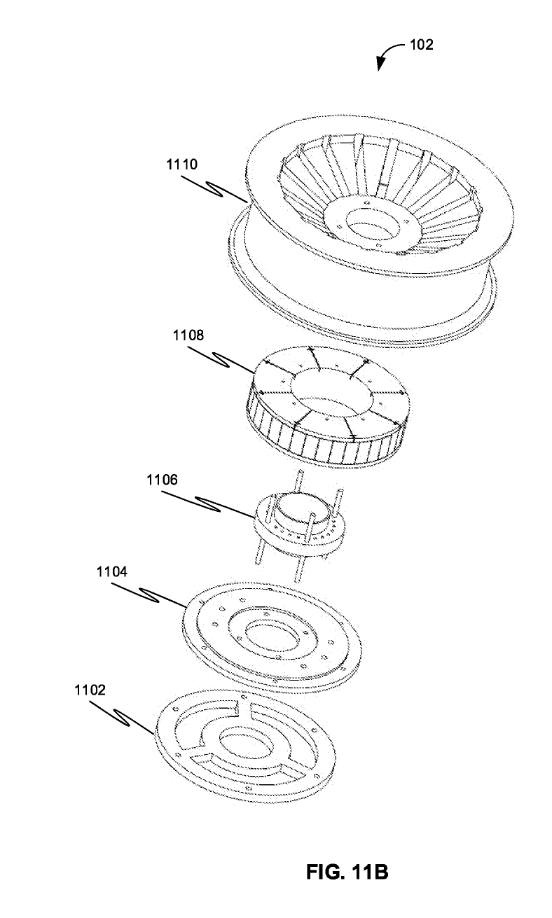

FIG. 2 illustrates a schematic diagram showing a wheel, such as the wheel 102, of the vehicle 100, in accordance with an embodiment. As explained in the FIG. 1, the wheel 102 may be mounted at one end of the axle 106 through the center 202 of the wheel 102. Further, FIG. 3 illustrates a schematic diagram of the axle 106, in accordance with some embodiments. The axle 106 may include a cylindrical rod 302 having wheel mounting assemblies 304-306. The wheel mounting assemblies 304-306 may be disposed at two opposite ends as shown in the FIG. 3. Further, the plurality of wheels 102-104 may be mounted at the wheel mounting assemblies 304-306 using a vehicle attachment mechanism included in each of the wheels 102-104. The vehicle attachment mechanism will be further explained in conjunction with FIG. 11B.

Further, the vehicle 100 may include a plurality of electric motors, such as for example, electric motors 110-112 corresponding to the plurality of wheels 102-104. Further, the electric motors 110-112 may be operationally coupled to the one or more axles, such as for example, axle 106 corresponding to the respective wheels, such as for example, wheels 102-104. Furthermore, the electric motors 110-112 may be configured to rotationally drive the one or more axles, such as the axle 106 based on electric power.

Moreover, each wheel of the plurality of wheels may be configured to rotate around a respective axle of the one or more axles. In other words, each of the plurality of electric motors 110-112 and the plurality of wheels 102-104 may be mounted on the axle 106 in such a way that on one hand the plurality of wheels 102-104 may be driven by the axle 106 while on the other hand, the plurality of wheels 102-104 may also be independently driven by the plurality of electric motors 110-112. Accordingly, in some instances, a net rotatory motion of a wheel of the plurality of wheels 102-104 may be based on a vector sum of a rotation imparted by the axle 106 corresponding to the wheel and a rotation imparted by an electric motor corresponding to the wheel. Further, in some embodiments, each of the electric motors 110-112 may be independently controlled. Accordingly, a speed of a respective wheel driven by an electric motor may be independently controlled.

Further, the electric power to operate the electric motors 110-112 may be supplied from inbuilt rechargeable-batteries 114 of the vehicle 100. In an instance, there may be a single rechargeable battery 114 configured to supply electric power to each of the plurality of electric motors 110-112. However, in some other embodiments, there may be multiple rechargeable batteries 114 configured to supply electric power to corresponding plurality of electric motors 110-112. Accordingly, in some instances, a rechargeable battery 114 may be co-located with a corresponding electric motor of the plurality of electric motors.

Further, the vehicle 100 may include one or more sensors 116 to sense a state of one or more parts of the vehicle 100. For example, the state of the one or more parts of the vehicle 100 may include one or more of a direction of motion, a speed, an acceleration and a deceleration. Further, the vehicle 100 may include a controller 118 configured to control operation of the plurality of electric motors 110-112 in accordance with the sensed state of the vehicle 100. The controller 118 may further be configured to control multiple parameters such as, but not limited to, a magnitude, a frequency and a polarity of the electromagnetic field generated in the electric motors 110-112.

Additionally, in some embodiments, the state of the one or more parts of the vehicle 100 may include a curved trajectory executed by the vehicle 100. In response to the vehicle 100 following the curved trajectory, the controller 118 may be configured to operate the one or more electric motors, such as the electric motor 110 at a first speed. At the same instance, the controller 118 may also be configured to operate one or more other electric motors, such as the electric motor 112 at a second speed based on the curved trajectory.

For example, assume that the vehicle 100 is executing a right turn and the electric motor 110 is operationally coupled to the wheel 102 situated on the right side of the vehicle 100 while the electric motor 112 is operationally coupled to the wheel 104 situated on the left side of the vehicle 100. Accordingly, since the wheel 104 has a greater distance to travel in comparison to the wheel 102 while making the right turn, the electric motor 112 may be driven at a speed higher than that of the electric motor 110. Accordingly, the wheel 104 may rotate a speed higher than that of the wheel 102. As a result, wearing out of a tire on the wheel 104 may be substantially reduced as compared to a case where each of the wheels 102 and 104 are rotating at the same speed. Further, a difference in speeds between the electric motors 110 and 112 may be controlled based on a degree of curvature of the curved trajectory sensed by the one or more sensors 116. Accordingly, the controller 118 may be configured to operate each of the one or more electric motors 110-112 to optimize the power transfer for propulsion while minimizing the power dissipated through friction. Consequently, uneven wearing out of tires on the plurality of wheels 102-104 may be minimized.

Further, the one or more sensors 116 of the vehicle 100 may also be configured to sense environmental conditions such as, but not limited to, dry/wet road surfaces, wind speeds, wind directions, thunderstorms, blind curves, and hilly roads. Further, the one or more sensors 116 may also be configured to sense a state of one or more of the plurality of wheels 102-104. The state of the plurality of wheels 102-104 may include data indicative of variables such as, but not limited to, wear and tear state, alignment values, air-pressure values, and temperature values. Further, the controller 118 may be configured to automatically control operation of the plurality of electric motors 110-112 based on one or more of the environmental conditions and state of the plurality of wheels 102-104.

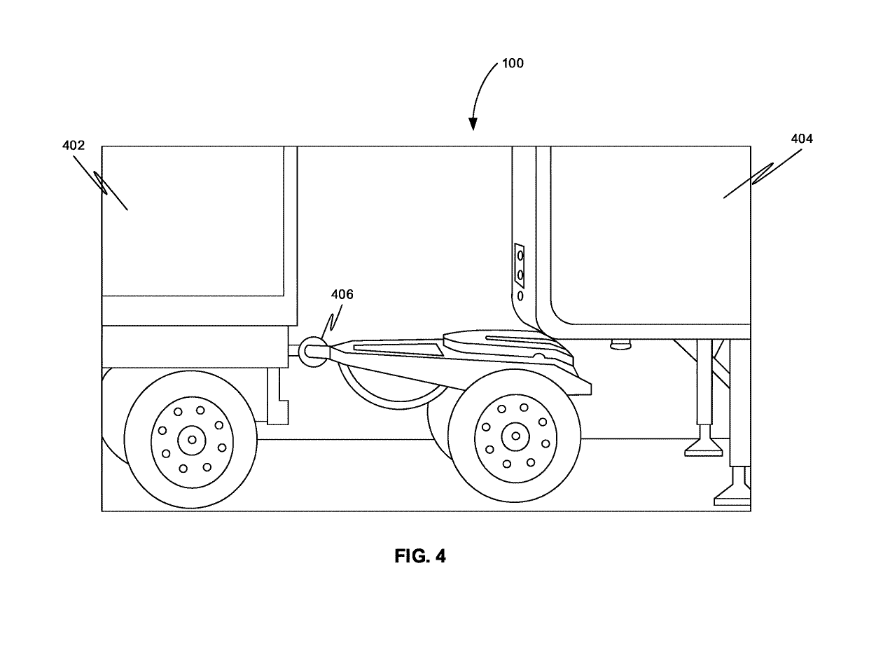

Referring to FIG. 4, in another embodiment, the vehicle 100 may include multiple segments, such as for example, a tractor 402 and a trailer 404 that may be interconnected through a hitch 406. The tractor 402 may include the engine 108 to propel the tractor 402. Further, the trailer 404 may be towed by the tractor 402. The trailer 404 may be configured to carry a load, freight, or any consignment. Further, the hitch 406 may be an interconnection device which may be in various forms such as, but not limited to, class 1 receiver hitch, class 2 receiver hitch, class 3 receiver hitch, class 4 receiver hitch, class 4 receiver hitch, weight distribution hitch, 4th wheel hitch, 5th wheel hitch, gooseneck hitch, and pintle hitch.

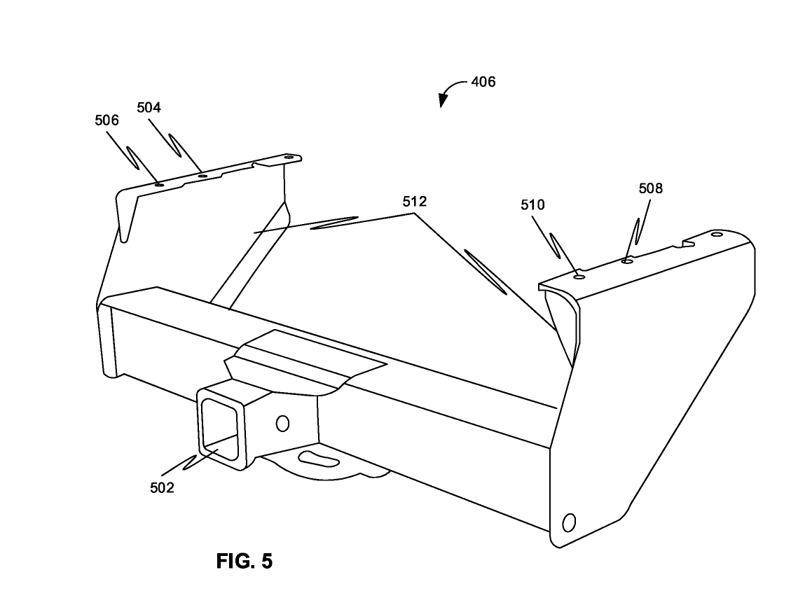

FIG. 5 illustrates a schematic diagram of the hitch 406 according to some embodiments. The hitch 406 may include a hook 502, multiple bolt holes 504-510, and a collar 512. Further, the hitch 406 may be capable to pull various types of segments such as, but not limited to, a heavy-duty trailer, a toy hauler, a dump trailer, a logging trailer, a gravity box and a small yacht trailer.

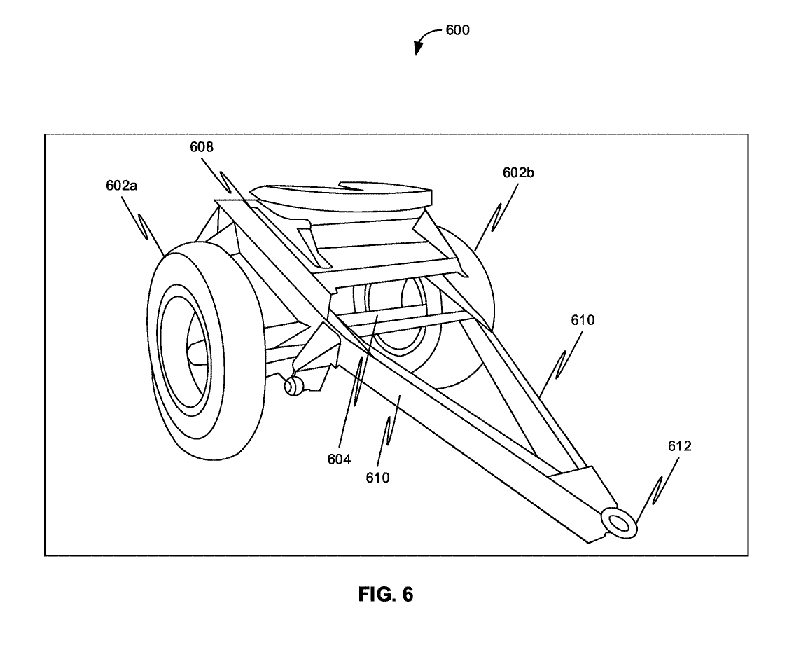

In an embodiment of the present disclosure, the vehicle 100 may be configured with multiple adjacent trailers 404. The multiple adjacent trailers 404 may be interconnected through a converter dolly. FIG. 6 illustrates a schematic diagram of an exemplary converter dolly 600. The converter dolly 600 may be configured with the one or more dolly wheels 602, such as for example, dolly wheels 602a-602b. The one or more dolly wheels 602 may be mounted on one or more dolly axles 604. Further, the one or more dolly wheels 602 may include one or more electric motors (not shown in figure). An electric motor may be operationally coupled to a respective dolly wheel of the one or more dolly wheels 602. Accordingly, a dolly wheel 602 may be driven by the respective electric motor in addition to the rotatory motion imparted to the dolly wheel as a result a towing force of a leading trailer of the multiple adjacent trailers 404. Further, in some embodiments, the controller 118 may be configured to control operation of the electric motor coupled to the dolly wheel 602 based on signals received from the one or more sensors 116. Furthermore, the electric motor coupled to the dolly wheel 602 may be controlled independent of one or more other electric motors included in the vehicle 100.

In other embodiment, the converter dolly 600 may be configured with a rectangular frame 608 that may be attached to multiple drawbars 610. The multiple drawbars 610 may expand and then converge towards a drawbar eye 612. The drawbar eye 612 may be configured to connect with the tractor 402 or the trailer 404.

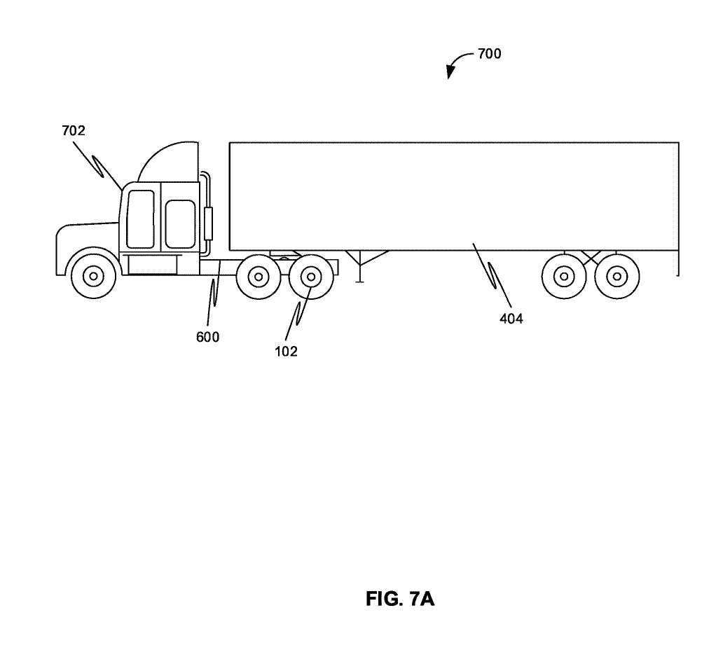

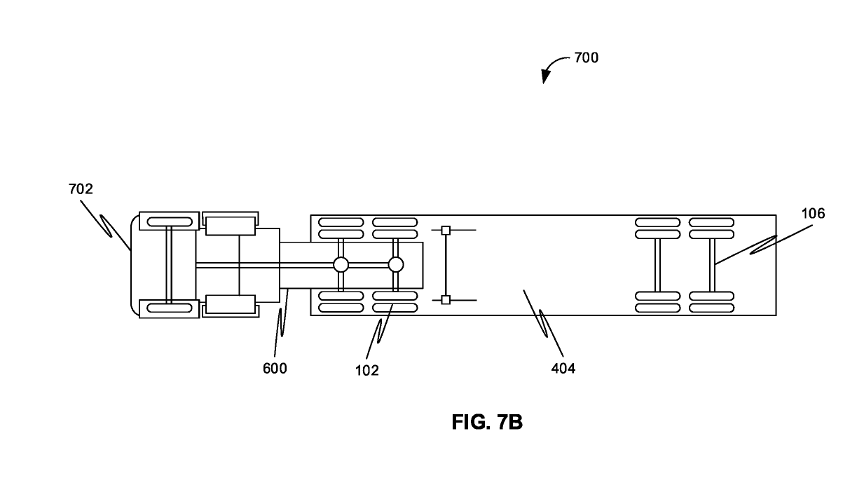

FIG. 7A illustrates a schematic diagram showing a side-view of the vehicle, such as for example, an eighteen wheeler 700, in accordance with an embodiment. The eighteen wheeler 700 may include a tractor 702, the trailer 404, and eighteen wheels 704 which may be instances of the plurality of wheels 102-104, the converter dolly 600, and a plurality of the axles 106. The trailer 404 may be interconnected to the tractor 702 through the converter dolly 600. Further, the eighteen wheeler 700 may include a plurality of electric motors (not shown in FIG. 7A), such as instances of electric motors 110-112 corresponding to a plurality of wheels of the eighteen wheels 704. In one instance, each of the eighteen wheels 704 may be operationally coupled to a corresponding electric motor of the plurality of electric motors. In another embodiment, each of the wheels 704 associated with the trailer 404 may be operationally coupled to the electric motor of the plurality of electric motors. In other words, in an instance, each wheel supporting the trailer 404 may include a corresponding electric motor.

Further, the plurality of electric motors may be operationally coupled to the plurality of axles 106. Accordingly, in an instance, each wheel of the wheels 704 may be driven by one or more of the plurality of axles and a corresponding electric motor of the plurality of electric motors. In another instance, each of the wheels 704 associated with the tractor 702 may be driven solely by one or more of the plurality of axles, while each of the wheels 704 associated with the trailer 404 may be driven by both a corresponding axle of the plurality of axles 106 and a corresponding electric motor of the plurality of electric motors.

Further, the controller 118 may be configured to control operation of the plurality of electric motors. Accordingly, in response to the state of the one or more parts of the eighteen wheeler 700, one or more of the plurality of wheels 102 may be controlled by controlling delivery of electric power to a corresponding one of the plurality of electric motors. Further, FIG. 7B illustrates a schematic diagram showing a bottom-view of the vehicle 100, such as for example, the eighteen wheeler 700, in accordance with an embodiment.

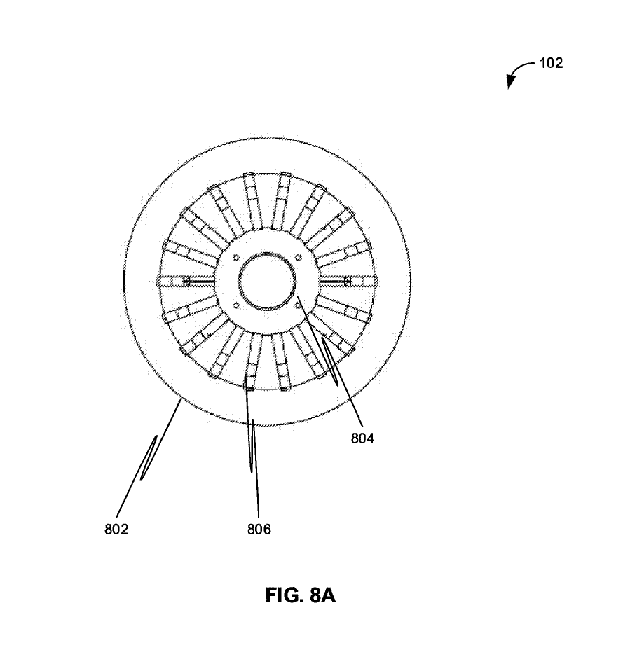

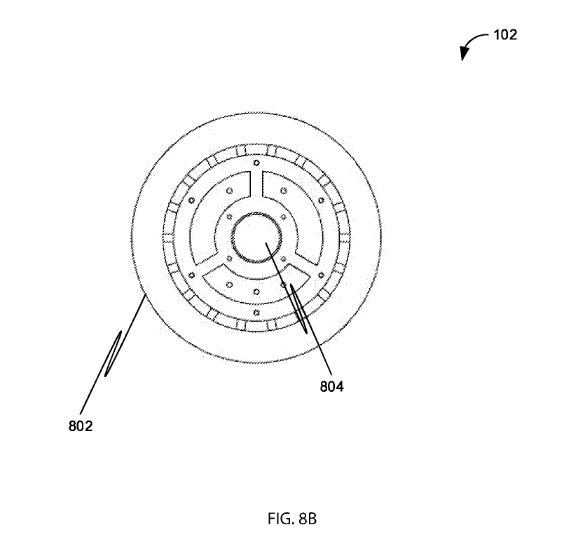

Referring now to FIGS. 8A and 8B, a front and a back view of the wheel 102 according to an embodiment, is shown. The wheel 102, which may be an instance of the plurality of wheels 102-104, may include a wheel rim rotor 802, a hub 804, and optionally, a plurality of spokes 806. According to some embodiments, the plurality of wheels 102-104 may be manufactured using one or more alloys of Aluminum and Magnesium. Accordingly, the plurality of wheels 102-104 may provide high strength while being light weight. Further, alloys of Aluminum and/or Magnesium may provide improved heat conduction.

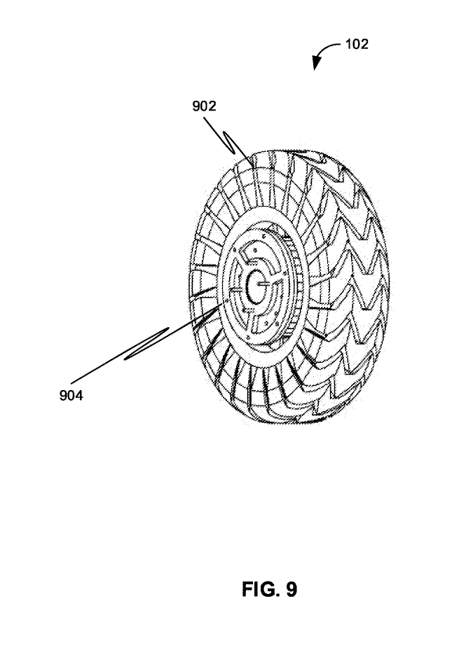

Furthermore, the wheel rim rotor 802 may be configured to support a tire. For example, FIG. 9 illustrates a perspective view of the wheel 102 having the tire 902 supported on the wheel rim rotor 904. The tire 902 may be manufactured from materials such as, but not limited to, a natural rubber, and synthetic rubber. Further, the tire 902 may provide a flexible covering to the wheel rim rotor 904 which helps in absorbing shocks when the vehicle 100 is in motion. Again referring to FIG. 8A-8B, the hub 804 may include a circular-shaped plate comprising the multiple spokes 806 and other components such as, but not limited to, a bearing, a bearing mount, a stator, and a rotor as explained in detail later on. The plurality of spokes 806 may be angularly attached from the center of the wheel 102 towards the circular edge of the wheel rim rotor 904.

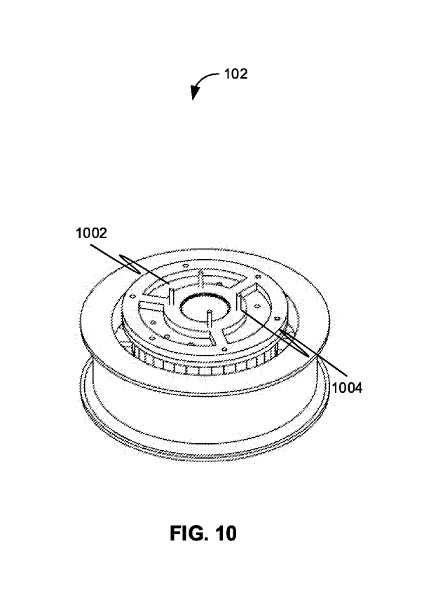

Further, FIG. 10 illustrates an isometric view of the wheel 102, in accordance with an embodiment. As explained in conjunction with FIG. 1, FIG. 4, and FIG. 7, the plurality of wheels 102-104 may be operationally coupled with the plurality of electric motors 110-112. For instance, as illustrated in FIG. 10, the wheel 102 may include a corresponding electric motor 1002 in a hub 1004 of the wheel. Accordingly, in an instance, the electric motor 1002 may be integrated inside the hub 1004 of the wheel 102 and be configured to drive the wheel 102 when mounted on an axle.

FIG. 11A illustrates an exploded perspective view of the wheel 102, in accordance with an embodiment. The wheel 102 may include a hub 1102, a stator 1104, a wheel bearing 1106, a rotor 1108, and a wheel rim 1110. The stator 1104 may be configured to be mounted on the axle 106 corresponding to the respective wheel 102 as shown in FIG. 1. Further, the stator 1104 may include a stationary winding assembly (not shown in fig). The stator 1104 winding may be configured to generate an electromagnetic field based on electric power supplied from an energy source, such as, for example, the rechargeable batteries 114. Further, the rotor 1108 may be mounted on the axle 106 corresponding to the respective wheel 102 via the wheel bearing 1106. The rotor 1108 may include one or more of annular arrays of magnets. The one or more annular arrays of magnets may be integrated into the rim of the wheel rim 1110, such that the electric fields generated by the stationary winding assembly impels the wheel rim 1110 to spin in either the clockwise or counter clockwise direction. In other words, the electromagnetic field generated by the stator 1104 may impel the rotor 1108, having the one or more of annular arrays of magnet, to rotate about a longitudinal axis of the axle 106 corresponding to the respective wheel 102. Further, the wheel rim 1110 may be configured to mount the tire 902 on the wheel 102.

FIG. 11B illustrates another exploded view of the wheel of the vehicle 100, in accordance with an embodiment.

Further, according to an embodiment, the wheel 102 may include a vehicle attachment mechanism (not shown in fig) that may be configured to attach the wheel 102 to the axle 106. The vehicle attachment mechanism may be a mechanical fastening assembly which may connect the wheel 102 to a suspension system (not shown in fig) of the vehicle 100.

According to some embodiments of the present disclosure, the wheel 102 may be formed as a wheel hub motor. The wheel hub motor may be an integral unit comprising a corresponding electric motor for driving the wheel hub motor around a corresponding axle 106. The wheel hub motor may remove the need for an external rim by facilitating a provision to integrate a tire mount into the exterior of the wheel rim 1110.

Accordingly, in some embodiments, the vehicle attachment mechanism may enable the wheel hub motor to rotate about the longitudinal axis of the axle 106, while preventing all linear displacement relative to the axle 106. Additionally, the vehicle attachment mechanism may be designed to form a detachable connection between the wheel hub motor and the vehicle 100. The detachable connection may be established to remove the wheel hub motor by disengaging the vehicle attachment mechanism. In one embodiment, the vehicle attachment mechanism may use a plurality of mechanical fasteners to fixedly connect the stator 1104 to the vehicle 100. In another embodiment, the vehicle attachment mechanism may be a clamping device that may be used to securely fasten the wheel hub motor to the suspension system of the vehicle 100. The stator mount may serve as the connection point which may maintain the stator 1104 in a desired position and orientation relative to the corresponding axle 106 of the connected vehicle 100. Further, the plurality of hub fasteners may be used to connect the stator 1104 to the stator mount.

Further, in an embodiment, the wheel 102 may include an electronic power unit comprising of an electrical interconnect and a stationary winding assembly configured to generate an electromagnetic field. Additionally, the electric interconnect may be configured to receive one or more of electric power to energize the stationary winding assembly and a control signal to control electrical power delivered to the stationary winding assembly. Further, the wheel 102 may include the stator 1104 which may be configured to be mounted onto the axle 106. The stator 1104 may include a bearing mount (not shown in fig) and a power unit mount (not shown in fig). The bearing mount may be configured to function as the connection point for the wheel bearing 1106. In addition, the electronic power unit mount may be configured to function as the connection point for the electronic power unit. The electronic power unit may be mechanically fastened to the stator 1104. Further, the wheel rim 1110 may be positioned in such a way that it may secure each of the hub 1102, the stator 1104, the wheel bearing 1106, the rotor 1108 in the wheel 102. As explained in conjunction with FIG. 11A, the wheel rim 1110 may include the one or more annular array of magnets. The annular array of magnets may be configured to interact with the electromagnetic field generated by the stationary winding assembly to generate a repulsive force which may impel the wheel rim 1110 comprising the rotor 1108 to rotate about the longitudinal axis of the one or more of axle 106

Further, the wheel rim 1110 may be secured to the axle 106 through the wheel bearing 1106. The wheel bearing 1106 may be configured to form the connection point between the wheel rim 1110 and the axle 106. Further, the wheel bearing 1106 may also be configured to enable the wheel rim 1110 to rotate about the longitudinal axis of the axle 106. While not shown, in some embodiments, the wheel 102 may house one or more sensors 116. The sensor 116 may be configured to sense one or more of an environmental condition of the vehicle 100 and the state of the wheel 102. As explained in previous embodiments in conjunction with FIG. 4, the application of the controller 118 may be employed to control the state of the tractor 402 and the one or more trailers 404. The real-time control of the vehicle 100 including the tractor 402 and the one or more trailers 404 may prevent the phenomenon of jackknifing. As explained earlier, the term jackknifing refers to the scenario in which the tractor 402 towing the one or more of trailers 404 skids because of an otherwise uncontrollable rotation of the wheels associated with the trailer 404. For example, as the vehicle 100 comes to a sudden halt, the one or more trailers 404 push the tractor 402 from behind until the tractor 402 spins around and faces rearwards. Here, the state of the tractor 402 and/or the trailer 404 may be indicative of a possible occurrence of jackknifing. For instance, sensors 116 situated on the tractor 402 may detect a sudden braking of the tractor 402 that may be indicate of a possibility of jackknifing. In response to this, the controller 118 may transmit a control signal to the plurality of electric motors 110-112 operationally coupled to the plurality of wheels 102-104 associated with the one or more trailers 404. Consequently, a braking action may be generated at the plurality of wheels 102-104. As a result, the controller 118 may be able to at least partially prevent jackknifing of the vehicle 100.

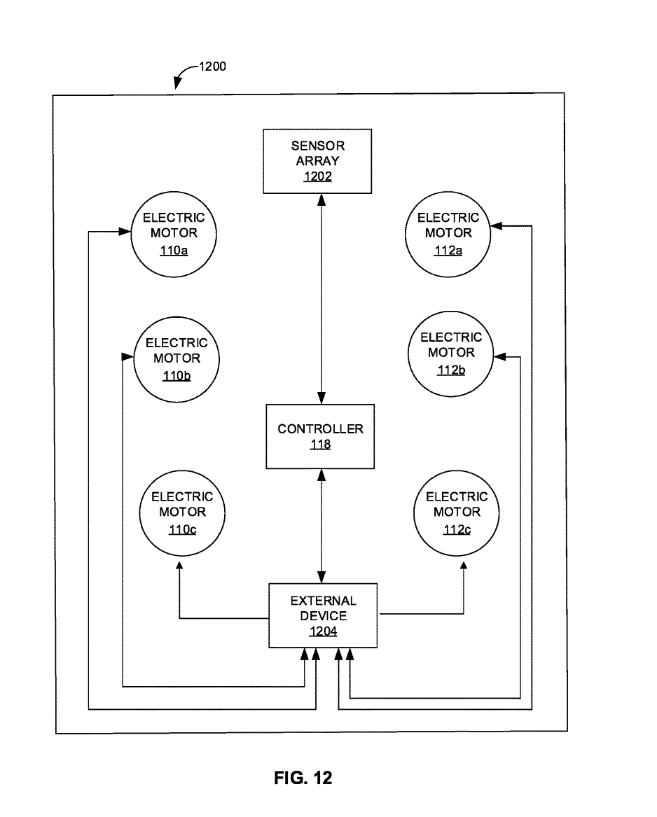

FIG. 12 illustrates the flowchart depicting operations of the controller 118, in accordance with an embodiment. In an embodiment of the present disclosure, the controller 118 may be an on-board computer system that may be used to control electric power delivered to the plurality of electric motors 110-112, such as for example, the electric motors 110a-c and 112a-c. Further, in some instances, the controller 118 may include a system on a chip (SOC), an external device interface, a sensor array 1202, a control circuit, and a power supply. Further, the controller 118 may be electrically connected to one or more of the plurality of electric motors 110-112. Furthermore, the controller 118 may monitor environmental conditions, and may also transmit the control signals to the connected one or more electric motors. The SOC may function as a central processor which may be capable of interpreting sensor data. Further, the SOC may be configured to execute commands transmitted from an external device 1204. Additionally, the SOC may be configured to transmit unique control signals to any of the connected one or more electric motors of the plurality of electric motors 110-112. In one embodiment, the controller 118 may include a wireless transmitter capable of wirelessly transmitting control commands to one or more of the plurality of electric motors 110-112. For example, the SOC may be equipped with a wireless radio that is able to connect to and communicate with devices via communication standards such as, but not limited to, RFID, ZigBee, Wi-Fi, Bluetooth, GSM, LTE, and Wi-Max. In another embodiment, the SOC may be deployed with a GPS module. The GPS module may enable users to accurately locate the vehicle 100 including plurality of wheels 102-104. In yet another embodiment, the controller 118 may enable the connected vehicle 100 to be remotely operated.

In an embodiment of the present disclosure, the external device interface may be an electrical interconnect which may enable one or more electric motors of the plurality of electric motors 110-112 to be physically connected to an external system. The electrical interconnect may facilitate the transfer of data and electrical power to the one or more electric motors. Further, the sensor array 1202 may include one or more of environmental sensors to assess the state of the vehicle 100. The environmental sensors may be configured to detect quantifiable values such as, but not limited to, road conditions, direction of travel, and wheel alignment. In an embodiment, the sensor array 1202 may work in conjunction with the SOC to detect the existence of a hazardous driving condition. Further, the sensor array 1202 may automatically modify the electric power delivered to individual electric motors of the plurality of electric motors 110-112 to compensate for these hazardous conditions. Accordingly, the control circuit may be configured to maintain the controller 118 in electrical communication with the one or more electric motors. Further, data may be relayed between the controller 118 and the one or more of electric motors through the control circuit. In an embodiment, the power supply may be configured to distribute the electric power to the one or more of electric motor. Further, the power supply may also be configured to distribute electric power to the components of the controller 118. In one embodiment, the vehicle 100 may include one or more rechargeable batteries 114 onboard the vehicle 100. The one or more rechargeable batteries 114 may be configured to satisfy the requisite power needs. In a separate embodiment, all power requirements may be provided by an externally connected device.

Although the invention has been explained in relation to its preferred embodiment, it is to be understood that many other possible modifications and variations can be made without departing from the spirit and scope of the invention.

We claim:

1. A vehicle comprising:
a plurality of wheels;
at least one axle, wherein each wheel is mounted on the at least one axle;
a plurality of electric motors corresponding to the plurality of wheels, wherein, each electric motor of the plurality of electric motors is operationally coupled to the at least one axle corresponding to a respective wheel of the plurality of wheels, wherein an electric motor operationally coupled to an axle is configured to rotationally drive the axle based on electrical power supplied to the electric motor;
at least one sensor configured to sense a state of at least one part of the vehicle; and
a controller configured to control operation of each of the plurality of electric motors based on the state of at least one part of the vehicle, wherein the controller is further configured to control operation of at least one electric motor independent of controlling operation of at least one other electric motor of the plurality of electric motors.

2. The vehicle of claim 1 comprising a plurality of segments, wherein at least two adjacent segments are interconnected through a hitch.

3. The vehicle of claim 2, wherein the plurality of segments comprises a tractor and a trailer, wherein the tractor comprises an engine configured to propel the tractor, wherein the trailer is towed by the tractor.

4. The vehicle of claim 2, wherein the plurality of segments comprises a tractor and a plurality of trailers, wherein the tractor comprises an engine configured to propel the tractor, wherein the plurality of trailers is towed by the tractor.

5. The vehicle of claim 4, wherein at least two adjacent trailers of the plurality of trailers are interconnected through a converter dolly, wherein the converter dolly comprises at least one dolly wheel mounted on at least one dolly axle, wherein each dolly wheel comprises an electric motor operationally coupled to the at least one dolly axle, wherein the controller is further configured to control operation of the electric motor comprised in each dolly wheel based on the state of at least one part of the vehicle.

6. The vehicle of claim 1, wherein each wheel of the plurality of wheels comprises a respective electric motor of the plurality of electric motors, wherein the respective electric motor is integrated in a hub of each wheel.

7. The vehicle of claim 6, wherein each wheel comprises:
a stator configured to be mounted onto the at least one axle corresponding to respective wheel, wherein the stator comprises a stationary winding assembly configured to generate an electromagnetic field; and
a rotor configured to be mounted on the at least one axle corresponding to respective wheel via a wheel bearing, wherein the rotor comprises an annular array of magnets, wherein the electromagnetic field generated by the stator impels the rotor to rotate about a longitudinal axis of the at least one axle corresponding to respective wheel

8. The vehicle of claim 7, wherein controlling operation of each electric motor comprises controlling at least one of a magnitude, a frequency and a polarity of the electromagnetic field generated by the stationary winding assembly of respective electric motor.

9. The vehicle of claim 1, wherein the state of the at least one part of the vehicle comprises at least one of a direction of motion, a speed, an acceleration and a deceleration of the at least one part.

10. The vehicle of claim 1, wherein the at least one sensor is further configured to sense an environmental condition corresponding to the vehicle, wherein the controller is further configured to control operation of each electric motor based further on the environmental condition.

11. The vehicle of claim 1, wherein the controller comprises a wireless transmitter capable of wirelessly transmitting control commands to each of the plurality of electric motors.

12. The vehicle of claim 1, wherein at least one wheel corresponding to the at least one electric motor and at least one other wheel corresponding to the at least one other electric motor are each mounted on a common axle.

13. A wheel configured to propel a vehicle, the wheel comprising:
a vehicle attachment mechanism configured to attach the wheel to an axle of the vehicle;
an electrical power unit comprising an electrical interconnect and a stationary winding assembly, wherein the stationary winding assembly is configured to generate an electromagnetic field, wherein the electrical interconnect is configured to receive at least one of electrical power to energize the stationary winding assembly and a control signal to control electrical power delivered to the stationary winding assembly;
a stator configured to be mounted onto the axle, wherein the stator comprises a bearing mount and a power unit mount, wherein the bearing mount is configured to function as a connection point for the wheel bearing, wherein the power unit mount is configured to functions as a connection point for the electronic power unit to be mechanically fastened to the stator;
a wheel rim rotor comprising an annular array of magnets configured to interact with the electromagnetic field generated by the stationary winding assembly to generate a repulsive force which impels the wheel rim rotor to rotate about a longitudinal axis of the axle;
a wheel bearing configured to form a connection point between the wheel rim rotor and the axle, wherein the wheel bearing is configured to enable the wheel rim rotor to rotate about the longitudinal axis of the axle;
at least one sensor configured to sense at least one of an environmental condition of the vehicle and a state of the wheel; and
a controller configured to control electric power delivered to the stationary winding assembly based on at least one of the environmental condition and the state of the wheel, wherein the controller is configured to at least partially prevent jackknifing of the vehicle.

14. The wheel of claim 13 further comprising a tire mount attached to an exterior surface of the wheel rim rotor, wherein the tire mount is configured to mount a tire onto the wheel.

15. The wheel of claim 13, wherein the vehicle attachment mechanism comprises a mechanical fastening assembly configured to connect the wheel to a suspension system of the vehicle.

16. The wheel of claim 13, wherein the vehicle attachment mechanism is configured to form a detachable connection between the wheel and the vehicle.

17. The wheel of claim 13, wherein the vehicle attachment mechanism comprises a plurality of mechanical fasteners configured to fixedly connect the stator to the vehicle.

18. The wheel of claim 17, wherein the vehicle attachment mechanism comprises a clamping device configured to securely fasten the wheel to the suspension system.

19. The wheel of claim 13 further comprising a stator mount configured to serves as a connection point to maintain the stator in a desired position and orientation relative to the axle of the vehicle, wherein the wheel further comprises a plurality of hub fasteners configured to connect the stator to the stator mount.

20. The wheel of claim 13, wherein the controller is further configured to control electrical power delivered to the stationary winding assembly in order to optimize power transfer for propulsion while minimizing power dissipated through friction.
